(19) United States
(12) Patent Application Publication
(10) Pub. No.: US 2025/0206318 A1
(43) Pub. Date: Jun. 26, 2025

(54) ESTIMATION METHOD FOR ROAD SURFACE CONDITION

(71) Applicant: TOYOTA JIDOSHA KABUSHIKI KAISHA, Toyota-shi (JP)

(72) Inventor: Nobuhiro TAZAWA, Toyota-shi (JP)

(73) Assignee: TOYOTA JIDOSHA KABUSHIKI KAISHA, Toyota-shi (JP)

(21) Appl. No.: 18/922,415

(22) Filed: Oct. 22, 2024

(30) Foreign Application Priority Data
Dec. 22, 2023 (JP) 2023-216708

(51) Int. Cl. B60W 40/06

(52) U.S. Cl. CPC B60W 40/06; B60W 2520/105; B60W 2540/106; B60W 2555/20; B60W 2556/50; B60W 2556/65

(57) ABSTRACT

The road surface condition estimation method includes a step of registering vehicle information acquired from a plurality of vehicles in an information processing device, a step of extracting a change in acceleration information when passing through the point by comparing the acquired travel information for the same point with other travel information registered in the information processing device, and a step of determining whether or not the change in acceleration information is due to a driving operation by a driver when a change in acceleration information is extracted. The above-described estimation method determines whether or not the change in the acceleration information is caused by the driving operation by the driver based on the travel information, and estimates that the change in the road surface condition has occurred when it is determined that the change in the acceleration information is not caused by the driving operation by the driver.

### CROSS-REFERENCE TO RELATED APPLICATION

This application claims priority to Japanese Patent Application No. 2023-216708 filed on Dec. 22, 2023, incorporated herein by reference in its entirety.

### BACKGROUND

### 1. Technical Field

The disclosure relates to an estimation method of a road surface condition.

### 2. Description of Related Art

Japanese Unexamined Patent Application Publication No. 2004-161116 (JP 2004-161116 A) discloses a road surface condition determination method for determining a condition of a road surface on which a four-wheel vehicle is traveling. In this road surface condition determination method, the condition of the road surface on which the four-wheel vehicle is traveling is determined from a relation between wheel speed rotation information of drive wheels of the four-wheel vehicle that is traveling, and acceleration information thereof.

### SUMMARY

In the above-described road surface condition determination method, only the road surface condition at the point where the own vehicle is traveling can be comprehended.

An estimation method of a road surface condition according to the disclosure estimates a condition of a road surface on which a vehicle is traveling.

An information processing device that is communicable with a plurality of vehicles acquires vehicle information that includes travel information including acceleration information and driving operation information while traveling, and position information, from the vehicles, and registers the vehicle information in a database.

The information processing device compares the travel information that is acquired with other travel information registered in the database regarding a same point, thereby extracting change in the acceleration information when passing the point.

The information processing device determines, when a change in the acceleration information is extracted, whether the change in the acceleration information is caused by a driving operation by a driver, based on the travel information at the point where the change in the acceleration information is extracted.

When determining that the change in the acceleration information is caused by the driving operation by the driver, the information processing device estimates that change in the road surface condition is not occurring at the point.

When determining that the change in the acceleration information is not caused by the driving operation by the driver, the information processing device estimates that change in the road surface condition is occurring at the point.

The above estimation method of a road surface condition enables change in road surface conditions to be comprehended at a plurality of points.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a configuration diagram schematically illustrating a configuration of a vehicle and an information processing device for performing a road surface condition estimation method according to an embodiment;

FIG. 2 is a flowchart of processing executed by a vehicle to implement the road surface condition estimation method according to the embodiment;

FIG. 3 is a flowchart of processing executed by the information processing device in order to implement the road surface condition estimation method according to the embodiment;

FIG. 4 is a schematic diagram showing a point A where flooding is likely to occur;

FIG. 5A is a schematic diagram for explaining travel information when a vehicle passes through a point A that indicates acceleration information;

FIG. 5B is a schematic diagram for explaining travel information when a vehicle passes through a point A that indicates an accelerator operation;

FIG. 5C is a schematic diagram for explaining travel information when a vehicle passes through a point A that indicates a brake operation;

FIG. 6A is a schematic diagram for explaining travel information when the vehicle passes through the point A while the vehicle is being driven and operated that indicates acceleration information;

FIG. 6B is a schematic diagram for explaining travel information when the vehicle passes through the point A while the vehicle is being driven and operated that indicates an accelerator operation;

FIG. 6C is a schematic diagram for explaining travel information when the vehicle passes through the point A while the vehicle is being driven and operated that indicates a braking operation;

FIG. 7A is a schematic diagram for explaining travel information when the vehicle passes through the flooded point A that indicates acceleration information;

FIG. 7B is a schematic diagram for explaining travel information when the vehicle passes through the flooded point A that indicates accelerator operation; and

FIG. 7C is a schematic diagram for explaining travel information when the vehicle passes through the flooded point A that indicates brake operation.

### DETAILED DESCRIPTION OF EMBODIMENTS

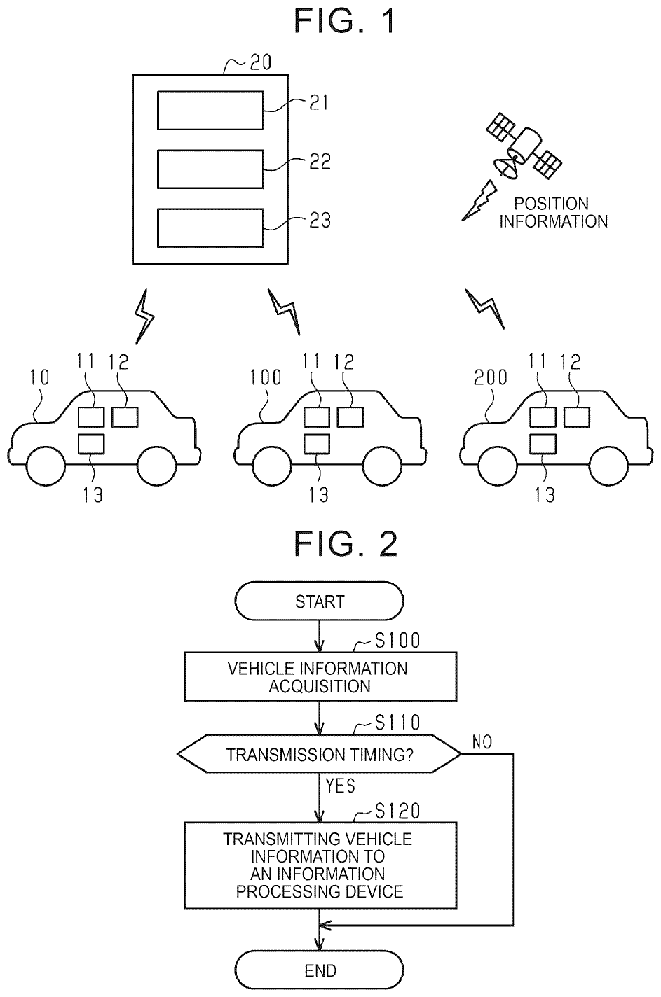

Hereinafter, an embodiment of a road surface condition estimation method will be described with reference to FIG. 1 to FIG. 7C.

### Configuration of the Vehicle 10 and the Information Processing Device 20

FIG. 1 schematically illustrates a configuration of a vehicle 10 and an information processing device 20 for performing a road surface condition estimation method according to an embodiment.

As illustrated in FIG. 1, the vehicle 10 includes a control device 11, a position information acquisition device 12, and a communication device 13. The control device 11 performs overall control for the vehicle 10, such as a travel condition control for controlling an engine, a transmission, a brake, and the like of the vehicle 10, and a communication control for controlling communication between the vehicle 10 and the outside. The position information acquisition device 12 receives a radio wave transmitted from a satellite and acquires position information of the vehicle 10. The communication device 13 can communicate with an external device of the vehicle 10, can transmit vehicle information to the external device, and can receive various kinds of information on weather, road surface conditions, and the like from the external device. The vehicle information includes travel information including acceleration information and driving operation information during traveling, and position information acquired by the position information acquisition device 12. Each of the other vehicles 100, 200 is configured to have the same configuration as the vehicle 10.

The information processing device 20 can communicate with a plurality of vehicles such as the vehicle 10 and other vehicles 100, 200, for example. As illustrated in FIG. 1, the information processing device 20 includes a vehicle information receiver 21, a database 22, and a processing device 23. The vehicle information receiver 21 acquires vehicle information from the plurality of vehicles 10. The database 22 registers information such as weather information and vehicle information acquired by the vehicle information receiver 21. The processing device 23 estimates a change in the road surface condition by comparing the travel information acquired by the vehicle information receiver 21 with other travel information registered in the database 22. The information processing device 20 may be configured using a plurality of computers. For example, the information processing device 20 may be configured by a plurality of server apparatuses.

### Processing by the Vehicle 10

With reference to FIG. 2, a flow of processing executed by the vehicle 10 in order to implement the road surface condition estimation method will be described. This series of processes may be started when the vehicle 10 starts traveling, or may be started in response to an operation for the driver to start the estimation of the road surface condition. The series of processing illustrated in FIG. 2 is repeatedly executed by the control device 11.

As illustrated in FIG. 2, when this series of processes is started, the control device 11 executes S100 process to acquire vehicle-information. The vehicle 10 accumulates the acquired vehicle information. When the vehicle-information is acquired in S100, the control device 11 advances the process to S110 to determine whether or not the vehicle-information is to be transmitted. The transmission timing is a timing at which information is transmitted to the information processing device 20. The transmission timing arrives at a predetermined time interval. The transmission timing can also be preset by the user.

When it is determined in S110 that the transmission timing is the transmission timing (S110: YES), the control device 11 advances the process to S120 and transmits the vehicle information to the information processing device 20. Then, the series of processing ends.

On the other hand, when it is determined in S110 that the transmission-timing is not reached (S110: NO), the control device 11 ends the process.

As described above, the control device 11 of the vehicle 10 transmits the accumulated vehicle information to the information processing device 20 each time the transmission timing is visited.

### Processing by the Information Processing Device 20

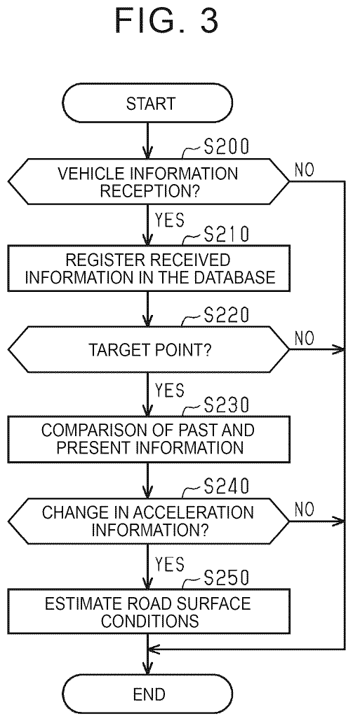

With reference to FIG. 3, a flow of processing executed by the information processing device 20 in order to perform the road surface condition estimation method will be described. The series of processing illustrated in FIG. 3 is repeatedly executed by the information processing device 20.

When this series of processing is started, the information processing device 20 executes the processing of S200 to determine whether or not the vehicle information has been received. When it is determined that the vehicle information has been received in S200 (S200: YES), the information processing device 20 advances the process to S210 and registers the received vehicle information in the database 22. On the other hand, when it is determined that the vehicle information has not been received in S200 (S200: NO), the information processing device 20 ends the process.

Next, the information processing device 20 advances the process to S220, and determines whether or not the point on which the vehicle 10 is traveling is a preset target point based on the position information included in the vehicle information. When it is determined in S220 that it is the target point (S220: YES), the information processing device 20 advances the process to S230. In S230, the information processing device 20 compares the travel information acquired from the vehicle information received in S200 with other travel information registered in the database 22 for the same target point. Accordingly, the information processing device 20 extracts a change in acceleration information when passing through the target point. The travel information registered in the database 22 is, for example, travel information in a normal condition in which no special change in the road surface condition has occurred, such as freezing of the road surface, flooding, or accumulation of fallen leaves. The travel information registered as the travel information in the normal condition is average travel information of many vehicles, and does not include travel information in which a specific driving operation is performed or deviates from the traveling condition of many vehicles. Then, the information processing device 20 advances the process to S240. On the other hand, when it is determined in S220 that it is not the target point (S220: NO), the information processing device 20 ends the process.

In S240, it is determined whether or not a change in the acceleration information has been extracted based on a result of comparing the travel information in S230. When it is determined in S240 that the change in the acceleration information has been extracted (S240: YES), the information processing device 20 advances the process to S250. Then, in S250, the information processing device 20 determines whether or not the change in the acceleration information is caused by the driver's driving operation, and estimates the road surface condition. That is, in S250, when it is determined that the change in the acceleration information is caused by the driving operation by the driver, the information processing device 20 estimates that the change in the road surface condition does not occur at the target point, and ends the process. On the other hand, in S250, when it is determined that the change in the acceleration information is not caused by the driving operation by the driver, the information processing device 20 estimates that the change in the road surface condition has occurred at the target point, and ends the process.

On the other hand, when it is determined in S240 that the change in the acceleration information has not been extracted (S240: NO), the information processing device 20 ends the series of processes.

Although a series of processes executed by the information processing device 20 has been described above, a preferred example of each process will be described below.
In S230 of extracting the change in the acceleration information, the information processing device 20 compares the travel information in which the types of vehicles are the same.
In S210 of registering the vehicle information in the database 22, the information processing device 20 registers the acquired vehicle information in the database 22 in association with the weather information. In S250 of estimating the road surface condition, when it is estimated that the road surface condition has changed, the information processing device 20 estimates the road surface condition based on the weather information.
In S250 of estimating the road surface condition, when it is estimated that a change in the road surface condition has occurred, the information processing device 20 also refers to the position information to estimate the road surface condition.

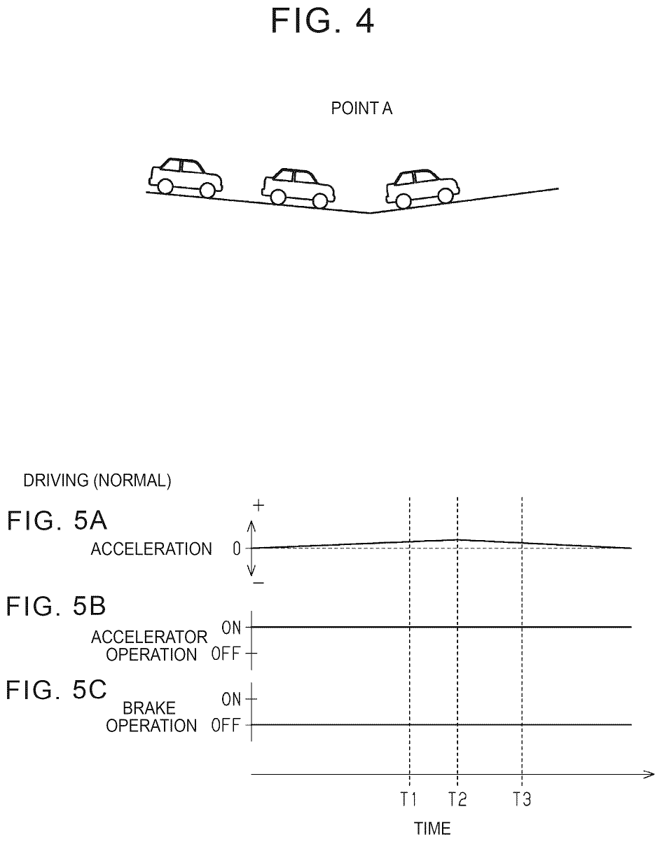

Hereinafter, with reference to FIGS. 4 to 7C, an example in which it is estimated that the road surface is flooded by using the road surface condition estimation method will be described. FIG. 4 shows, by way of example, a point A at which flooding is likely to occur. As shown in FIG. 4, at point A, the road surface is inclined. At point A, the slope of the road surface changes halfway from a downward slope to an upward slope. The slope changes from a downward slope to an upward slope, which is the lowest, and this portion is likely to be flooded.

FIGS. 5A to 5C show travel information when passing through a point A in a normal condition where flooding has not occurred. In this case, the accelerator operation is maintained as “on” as shown in FIG. 5B, and the brake operation is maintained as “off” without changing to “on” as shown in FIG. 5C. Therefore, as shown in FIG. 5A, the acceleration changes in accordance with the road surface gradient at the point A. That is, during the down slope, the acceleration gradually increases. After the slope of the road surface becomes an upward slope at the time T2, the acceleration gradually decreases.

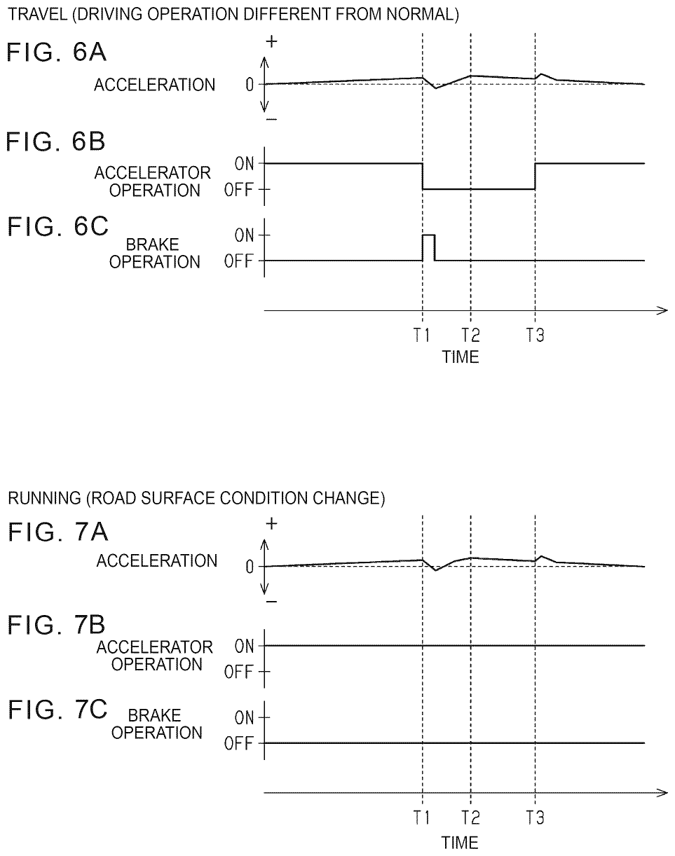

FIGS. 6A to 6C show travel information when a driver decelerates the vehicle 10 and passes through a point A in a normal condition where flooding is not occurring, unlike many vehicles. In this case, in the time T1 prior to the time T2 at which the slope of the road surface becomes the upward slope, the accelerator operation is turned from “on” to “off” as illustrated in FIG. 6B. As shown in FIG. 6C, the braking operation is turned from “off” to “on” in the time T1. As illustrated in FIG. 6B, the accelerator is maintained at “off” until the time T3 after the time T2 is reached. The accelerator is set to “ON” in time T3. Here, as shown in FIG. 6A, the acceleration decreases not only by the change in the slope of the road surface at the time T2 but also by the braking operation from “on” to “off” at the time T1. In addition, it is raised by the accelerator operation from “off” to “on” in the time T3. Therefore, the information processing device 20 extracts the change in the acceleration information shown in FIG. 6A as compared with the travel information shown in FIGS. 5A to 5C.

In the case of the example illustrated in FIGS. 6A to 6C, the change in the acceleration information is extracted, but the driving operation is performed by the driver. Therefore, the information processing device 20 determines that the change in the acceleration information is caused by the driving operation by the driver. In this case, the information processing device 20 estimates that there is no change in the road surface condition.

FIGS. 7A to 7C show travel information when passing through the flooded point A. In this case, as shown in FIG. 7B and FIG. 7C, the accelerator operation and the brake operation are maintained without changing in the same manner as FIG. 5B and FIG. 5C, respectively. However, in this case, as shown in FIG. 7A, the acceleration decreases in the time T1 and the acceleration increases in the time T3 as in FIG. 6A. This is because the vehicle 10 enters the flooded portion at the time T1 and the speed becomes slower, while the vehicle escapes from the flooded portion at the time T3 and the speed becomes faster. The information processing device 20 extracts a change in the acceleration information illustrated in FIG. 7A as compared with the travel information illustrated in FIGS. 5A to 5C.

In the case of the example illustrated in FIGS. 7A to 7C, the driving operation by the driver is not performed, but the change in the acceleration information is extracted. Therefore, the information processing device 20 determines that the change in the acceleration information is not caused by the driving operation of the driver. In this case, the information processing device 20 estimates that a change has occurred in the road surface condition.

The information processing device 20 also refers to the weather information and the position information to estimate the road surface condition. The information processing device 20 can recognize that the point where the vehicle 10 has passed is the point A based on the position information and is a terrain where flooding is likely to occur. The information processing device 20 can recognize that it is raining on the basis of the weather information or immediately after it rains. Therefore, the information processing device 20 can estimate that the road surface condition at the point A is flooded by referring to the position information and the weather information.

An example of estimating the change in the road surface condition due to flooding has been described above with reference to FIGS. 4 to 7C. The road surface condition estimation method of the present embodiment can also estimate the change in the road surface condition due to freezing or accumulation of fallen leaves in the same manner.

For example, when the vehicle 10 is cruising at a flat point at a constant speed, the opening degree of the accelerator operation is maintained constant, and the brake operation is not performed. Therefore, the acceleration of the vehicle 10 is maintained without change.

When a part of the road surface is frozen at the above-described flat point, even if the driving operation is not performed, when the vehicle 10 enters the frozen portion, the wheels slip and the acceleration temporarily rises. Then, when the vehicle exits the frozen portion, the wheels grip the road surface, and the acceleration temporarily decreases.

On the other hand, even if the road surface is not frozen, when the vehicle 10 passes through the above-described flat road surface, the acceleration change similar to that in the case where the vehicle is frozen may occur due to an accelerator operation or a brake operation of the driver.

Therefore, the information processing device 20 excludes the change in the acceleration information caused by the driving operation by the driver. Further, the information processing device 20 can estimate that the freezing has occurred at the point by determining that the road surface is highly likely to be frozen from the weather information and the position information.

Even when fallen leaves are deposited on the road surface, slippage of the wheels may occur as in the case where the road surface is frozen. The information on the season, date, time, and weather can be grasped from the climate information. This makes it possible to grasp, from the climate information, whether it is a condition in which freezing is likely to occur or a condition in which the accumulation of fallen leaves is likely to occur. From the position information, it is possible to grasp whether a point where the vehicle 10 is traveling is a point where freezing is likely to occur or a point where accumulation of fallen leaves is likely to occur. Therefore, the information processing device 20 can estimate that the condition of the road surface is the accumulation of fallen leaves by using the weather information and the position information together.

### Operations of Present Embodiment

The information processing device 20 estimates the condition of the road surface on which the vehicle 10 is traveling.

An information processing device 20 capable of communicating with the plurality of vehicles 10 acquires vehicle information that includes travel information including acceleration information and driving operation information while traveling, and position information from the plurality of vehicles 10 and registers the vehicle information in a database 22. The information processing device 20 compares the acquired travel information for the same point with other travel information registered in the database 22, thereby extracting a change in acceleration information when passing through the point. When the change in the acceleration information is extracted, the information processing device 20 determines whether or not the change in the acceleration information is caused by the driving operation by the driver based on the travel information at the point where the change in the acceleration information is extracted. When it is determined that the change in the acceleration information is caused by the driving operation by the driver, the information processing device 20 estimates that the change in the road surface condition does not occur at the point. When it is determined that the change in the acceleration information is not caused by the driving operation by the driver, the information processing device 20 estimates that the change in the road surface condition occurs at the point.

The information processing device 20 provides information on the road surface condition estimated for each target point.

For example, in a case where it is estimated that a change in the road surface condition has occurred at a target point on a route to be guided in the navigation system, information on the estimated road surface condition is displayed or read out by voice to notify the driver. The information processing device 20 notifies that the road surface condition has changed when it is estimated that the road surface condition has changed even if the road surface condition has not been specified.

In addition, the estimated road surface condition of each target point may be disclosed so that the estimated road surface condition of each target point is displayed together with the maps on Web website.

As a result, the user can grasp the road surface conditions of not only the points where the user is traveling but also a plurality of points in advance.

### Effects of Present Embodiment

(1) When the condition of the road surface is changed, slippage of the wheels or the like occurs, and a change that is different from usual appears in the acceleration information of the vehicle 10. If the road surface condition has not changed, the acceleration information when passing through the same point should be of the same degree. However, even if the road surface condition is not changed, the change of the acceleration information may be extracted due to the driving operation by the driver. The road surface condition estimation method determines whether or not the change in the acceleration information is caused by a driving operation performed by the driver based on the travel information. Then, when it is determined that the change in the acceleration information is not caused by the driving operation by the driver, it is estimated that the change in the road surface condition has occurred. Therefore, in the above estimation method, it is possible to prevent erroneous estimation of a change in the road surface condition based on the change in the acceleration information extracted due to the driving operation by the driver.

Further, in the above estimation method, the vehicle information acquired from the plurality of vehicles 10, 100, 200 is registered in the information processing device 20. Then, the above estimation method estimates that a change in the condition of the road surface has occurred by using the information including the travel information acquired from the other vehicle 100, 200 registered by the information processing device 20. Therefore, in the above-described road surface condition estimation method, it is possible to grasp changes in road surface conditions at a plurality of points.

(2) When the change in the acceleration information is extracted, the information processing device 20 compares the travel information in which the types of vehicles are common.

If there is no change in the condition of the road surface of the plurality of vehicles 10, the travel information of the vehicles having the same type of vehicles becomes particularly similar. The road surface condition estimation method described above compares travel information in which the types of vehicles are common. Therefore, it is possible to suppress the difference in the travel information due to the difference in the type of the vehicle from affecting the estimation result. Therefore, the estimation method described above can accurately grasp the change in the condition of the road surface.

(3) When the vehicle information is registered in the database 22, the information processing device 20 registers the acquired vehicle information in the database 22 in association with the weather information. When it is estimated that a change in the road surface condition has occurred, the information processing device 20 estimates the road surface condition based on the weather information.

For example, in the case of heavy rainfall, it is highly likely that the change in the condition of the road surface is due to flooding. In the case of heavy snow, it is likely that a change in the condition of the road surface is a freezing of the road surface. In the case of the fallen leaves season, the change in the condition of the road surface is likely to be the deposition of fallen leaves on the road. As in the above estimation method, by referring to the weather information, it is possible to estimate the condition of the road surface such as flooding, freezing, and accumulation of fallen leaves.

(4) When it is estimated that a change in the road surface condition has occurred, the information processing device 20 also refers to the position information to estimate the road surface condition.

There are terrain and regions where specific road surface conditions are likely to occur, such as places where flooding is likely to occur, places where road surfaces are likely to freeze, and places where fallen leaves are likely to accumulate. The above estimation method estimates the road surface condition by referring also to the position information. Therefore, the road surface condition can be estimated more accurately.

(5) The information processing device 20 estimates whether or not a change in the condition of the road surface has occurred only for the target point set in advance. For example, a point where flooding is likely to occur may be known in advance. At locations where many deciduous trees are planted in the vicinity, the deciduous leaves are likely to accumulate. A region where snow is likely to fall in winter can also be identified in advance. The road surface is likely to freeze at points where the road surface temperature tends to decrease, such as bridges and land bridges. In this way, a point at which a change in the road surface condition is likely to occur can be specified in advance. The road surface condition estimation method described above estimates whether or not a change in the road surface condition has occurred only at a preset target point. Therefore, the estimation can be performed by focusing on a point where the change in the road surface condition can be estimated, and the reliability of the estimation result can be improved.

### Modifications

The present embodiment can be realized with the following modifications. The present embodiment and the following modifications can be combined with each other within a technically consistent range to be realized.
In S230 of extracting the change in the acceleration information, the information processing device 20 compares the travel information in which the types of vehicles are the same. However, the information processing device 20 may extract a change in acceleration information by comparing travel information of a plurality of similar types of vehicles. The information processing device 20 may extract the change in the acceleration information by comparing the travel information of vehicles of different types without considering the type of the vehicle.
In the present embodiment, flooding, freezing, and depositing of fallen leaves are described as examples of the road surface conditions to be estimated. The road surface condition estimated by the information processing device 20 may include another road surface condition in which a slip of a wheel or the like occurs and a change that is different from usual appears in the acceleration information of the vehicle 10.
When the obtained travel information is compared with other travel information registered in the database 22, it is not always necessary to compare the travel information in the normal condition. In short, the information processing device 20 may compare the travel information with the travel information when it is estimated that the road surface condition is a specific road surface condition in the past. For example, the information processing device 20 may estimate that flooding has occurred when the acquired travel information is similar to the travel information when it is estimated that flooding has occurred in the past.

What is claimed is:

1. An estimation method of a road surface condition on which a vehicle is traveling, the estimation method comprising:
acquiring vehicle information including position information and travel information acquired from a plurality of vehicles by an information processing device that is communicable with the vehicles, and registering the vehicle information in a database, the travel information including acceleration information and driving operation information while traveling;
extracting change in the acceleration information when passing a point, by the information processing device comparing the travel information that is acquired with other travel information registered in the database regarding the same point;
determining by the information processing device, when a change in the acceleration information is extracted, whether the change in the acceleration information is caused by a driving operation by a driver, based on the travel information at the point where the change in the acceleration information is extracted;
estimating that no change in the road surface condition is occurring at the point when determination is made that the change in the acceleration information is caused by the driving operation by the driver; and
estimating that change in road surface condition is occurring at the point when determination is made that the change in the acceleration information is not caused by the driving operation by the driver.

2. The estimation method according to claim 1, wherein, in the extracting of change in the acceleration information, the information processing device compares the travel information in which types of vehicles are in common.

3. The estimation method according to claim 1, wherein:
in the registering of the vehicle information in the database, the information processing device associates the vehicle information that is acquired with weather information and performs registration in the database; and
when estimation is made that change in the road surface condition is occurring, the information processing device estimates the road surface condition based on the weather information.

4. The estimation method according to claim 3, wherein, when estimation is made that change in the road surface condition is occurring, the information processing device also refers to the position information to estimate the road surface condition.

5. The estimation method according to claim 1, wherein estimation is made regarding whether change in the road surface condition is occurring only at an object point set in advance.
